(19) United States
(12) Patent Application Publication
(10) Pub. No.: US 2025/0079560 A1
(43) Pub. Date: Mar. 6, 2025

(54) INTEGRATED COOLING PLATES WITH BATTERY ENCLOSURES

(71) Applicants: Venugopal GARIMELLA, Troy, MI (US); Miguel MERINO, Sterling Heights, MI (US); Elizabeth Lopez LOPEZ, Bloomfield Hills, MI (US); MAGNA INTERNATIONAL INC., Aurora (CA)

(72) Inventors: Venugopal GARIMELLA, Troy, MI (US); Miguel MERINO, Sterling Heights, MI (US); Elizabeth Lopez LOPEZ, Bloomfield Hills, MI (US)

(21) Appl. No.: 18/718,212

(22) PCT Filed: Dec. 15, 2022
(86) PCT No.: PCT/US2022/052919

§ 371 Date: Jun. 10, 2024

Related U.S. Application Data
(60) Provisional application No. 63/290,298, filed on Dec. 16, 2021.

(51) Int. Cl. H01M 10/6554; H01M 10/613; H01M 10/653; H01M 10/6556; H01M 50/204; H01M 50/224; H01M 50/276; H01M 50/278; H01M 50/28

(52) U.S. Cl. CPC H01M 10/6554; H01M 10/613; H01M 10/653; H01M 10/6556; H01M 50/204; H01M 50/224; H01M 50/276; H01M 50/278; H01M 50/28

(57) ABSTRACT

An integrated battery cooling system includes a battery enclosure and a plate attached directly to the battery enclosure. The battery enclosure or the plate includes a wave-like cross-section that combines with the other to define coolant channels therebetween. The battery enclosure may have the wave-like structure and a flat cover plate may be attached to the top of the wave-like structure. A lower plate may include the wave-like structure and may be attached to the bottom of the battery enclosure. Coolant may pass through the coolant channels defined between the battery enclosure and the plate to draw heat away from battery cells housed within the battery enclosure.

### CROSS-REFERENCE TO RELATED APPLICATION

This PCT International Patent Application claims the benefit of U.S. Provisional Patent Application Ser. No. 63/290,298, filed on Dec. 16, 2021 and titled “Integrated Cooling Plates With Battery Enclosures,” the entire disclosure of which is hereby incorporated by reference.

### TECHNICAL FIELD

The present disclosure relates to battery structures for use in EV architecture. More particularly, the present disclosure relates to cooling structure for the battery assembly.

### BACKGROUND OF THE DISCLOSURE

Passenger vehicles, and in particular electric vehicles, allow the vehicle to travel a certain distance before requiring that vehicle be re-charged or re-fueled. Traditional passenger vehicles with a gas-powered internal combustion engine are limited in range by the efficiency of the combustion engine and the amount of fuel that the vehicle can hold. Electric vehicles with a battery-operated electric motor are limited in range by the efficiency of the motor and the charging capacity of the battery that powers the electric motor.

Electric vehicle (EV) architecture may include a battery assembly that is attached to the vehicle body, and which provides the power to the vehicle. The battery assembly is typically in the form of an enclosed structure, which houses the battery cells and includes various structural features for mounting the battery cells within the structure and for mounting the battery assembly to the vehicle structure. The battery assembly may also include other internal components, such as control architecture.

The battery assembly includes a battery enclosure structure, which may also be referred to as a bottom enclosure, which can support the battery cells and/or battery modules within the battery assembly. The battery assembly also includes some form of top and side structure to complete the battery assembly and enclose the battery cells therein.

During operation, the battery cells will undergo increased heating. To manage the thermal properties of the battery cells, the battery assembly includes cooling structure, including a network of cooling channels, with coolant being introduced into the battery assembly via a pipe or other external conveying structure. The coolant may cycle within the battery assembly adjacent the battery cells, thereby allowing heat to transfer to the coolant and cooling the battery cells, with the coolant being routed out of the battery for further processing.

To increasing cooling, the path of the coolant may be routed in a serpentine fashion along the battery cells to increase the surface area in contact with the battery. These serpentine channels are provided via a separate structure that is attached/mounted to the bottom enclosure.

The separate structure that defines the serpentine channel is in the form of an external cooling plate (being external to the battery cell). The cooling plate is an assembly of two parts: a lower plate and a cover plate. The lower plate has a wave-like or corrugated shape that defines, at least in part, a serpentine path or a plurality of channels. The cover plate is attached to the top of the cooling plate and transmits thermal energy from the battery cells. When assembled, the coolant will pass along the channels defined between the lower plate and the cover plate.

The cooling plate assemblies are separate assembled structures that are first assembled together to combine the lower plate and the cover plate. The assembled cooling plate assembly is then later assembled with the bottom enclosure. This process is inefficient in that it requires separate design, manufacture, and assembly of the overall cooling plate prior to assembly within the bottom enclosure. This process further increases mass of the overall battery assembly and has increased cost, both in terms of material and assembly time.

Thus, improvements can be made in EV battery cooling architecture.

### SUMMARY OF THE INVENTION

In one aspect, an integrated battery cooling system includes: a battery enclosure configured for housing one or more battery cells therein; a plate attached to the battery enclosure; a coolant path defined by the battery enclosure and the plate, wherein one of the battery enclosure and the plate has a wave-like structure that combines with the other of the battery enclosure and the plate to define the coolant path between the plate and the battery enclosure.

In one aspect, the battery enclosure includes the wave-like structure and the plate is a cover plate attached to the top of the wave-like structure to define the coolant path therebetween.

In one aspect, the plate is a lower plate and includes the wave-like structure, wherein the lower plate is attached to the bottom of the battery enclosure to define the coolant path therebetween.

In one aspect, the plate is a corrugated plate including a wave-like cross-section. In one aspect, the corrugated plate can be attached to a bottom of the battery enclosure on the outside of the enclosure, or alternatively, on the inside of the battery enclosure.

In one aspect, the plate is a flat plate having a planar cross-section.

In one aspect, the battery enclosure is steel and the cover plate is steel. In one aspect, the steel battery enclosure has the wave-like structure and the cover plate is flat.

In one aspect, the battery enclosure is aluminum and the plate is aluminum. In one aspect, the aluminum battery enclosure has the wave-like structure and the plate is a flat cover plate. In another aspect, the aluminum battery enclosure is flat the plate is a corrugated lower plate.

In one aspect, the battery enclosure is plastic or fiber reinforced plastic, and the cover plate is aluminum. In one aspect, the plastic or fiber reinforced plastic battery enclosure has the wave-like structure and the cover plate is flat. In one aspect, the fiber reinforced plastic of the battery enclosure may be glass fiber or carbon fiber.

In one aspect, the battery enclosure is steel and the plate is steel. The steel battery enclosure has the wave-like structure, and the plate is a flat cover plate.

In one aspect, the structure adjacent the battery cell is flat and aluminum or steel, which can be either the battery enclosure or the plate, and the other structure (either the battery enclosure or the plate, whichever is not the structure adjacent the battery cell) is the wave-like structure, and can be steel, aluminum, plastic, or fiber reinforced plastic.

In one aspect, the plate is a single plate and does not define enclosed channels until being attached directly to the battery enclosure.

In another aspect, a method of integrating a cooling channel with a battery enclosure includes the steps of: providing a battery enclosure for housing one or more battery cells therein; attaching a plate to the battery enclosure, and defining a coolant channel between the plate and the battery enclosure, wherein the coolant channel is configured to remove heat from the battery cells; wherein one of the battery enclosure or the plate includes a wave-like structure, and attaching the plate to the battery enclosure defines the coolant channel within the wave-like structure.

In one aspect, the battery enclosure includes the wave-like structure and the plate is a cover plate, wherein the method includes attaching the cover plate to the top of the wave-like-structure to define the coolant channels.

In one aspect, the plate is a lower plate and includes the wave-like structure, and the method includes attaching the lower plate to the bottom of the battery enclosure to define the coolant channels.

### BRIEF DESCRIPTION OF THE DRAWINGS

Other advantages of the present invention will be readily appreciated, as the same becomes better understood by reference to the following detailed description when considered in connection with the accompanying drawings wherein:

FIGS. 1A-1C illustrate a traditional external cooling plate assembly that is attached to a battery enclosure;

FIG. 2 is an exploded view of a battery enclosure and cover plates, with the battery enclosure including a wave-like structure and serpentine formation in accordance with an aspect of the disclosure;

FIG. 3 is a partial cross-section view illustrating the cover plate attached directly to the wave-like structure formed in the battery enclosure with a coolant channel defined between the wave-like structure of the battery enclosure and the cover plate;

FIG. 4 is an enlarged cross-sectional view of the direct attachment of the cover plate to the battery enclosure;

FIG. 5 is an exploded view of a battery enclosure and lower plates, with the lower plates having the wave-like structure and serpentine formation configured for attachment to the bottom of the battery enclosure;

FIG. 6 is a cross-sectional view of the lower plate with the wave-like structure directly attached to the battery enclosure and defining the coolant channel therebetween;

FIG. 7 is an exploded view of a battery enclosure having the wave-like structure and cover plates configured for attachment to the battery enclosure;

FIG. 8 is a cross-sectional view illustrating the cover plate attached to the top of the battery enclosure having the wave-like structure and defining the coolant channel therebetween; and

FIG. 9 illustrates the serpentine path or channels formed between the wave-like structure and the plate, defining a region of enclosed channels between an inlet and outlet where flow velocity occurs;

FIG. 10 illustrates the serpentine path or channels formed between the wave-like structure and the plate, defining a region of enclosed channels between an inlet and outlet where cool temperature occurs; and

FIG. 11 illustrates the serpentine path or channels formed between the wave-like structure and the plate, defining a region of enclosed channels between an inlet and outlet where a coolant pressure drop occurs.

### DESCRIPTION OF THE ENABLING EMBODIMENT

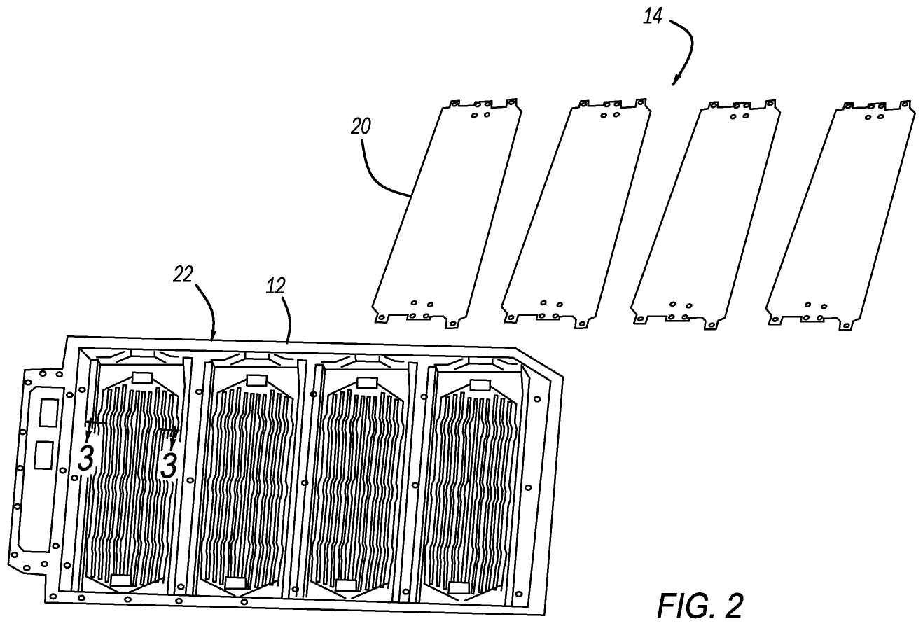

Referring to the Figures, in particular FIGS. 2-11, a system 10, 110, 210 for integrating a cooling plate with a battery enclosure is provided. In one aspect, the system 10 may include a bottom battery enclosure 12 and a plate 14 attached thereto, with the bottom battery enclosure 12 and the plate 14 combining to define a coolant channel 16 therebetween, without the use of a separate assembled structure, commonly referred to as an external cooling plate or cooling plate assembly, that defines coolant channels and that is attached to the battery enclosure and to the battery cells within the enclosure. The plate 14 of the present disclosure may be in the form of a cover plate that mates with a corrugated or wave-like bottom of battery enclosure 12, or the plate 14 itself may be corrugated or wave-like and mate with a flat surface of the battery enclosure 12. These various embodiments will be described in further detail below. The system 10 of the present disclosure allows for the integration of the cooling structure with the bottom enclosure 12.

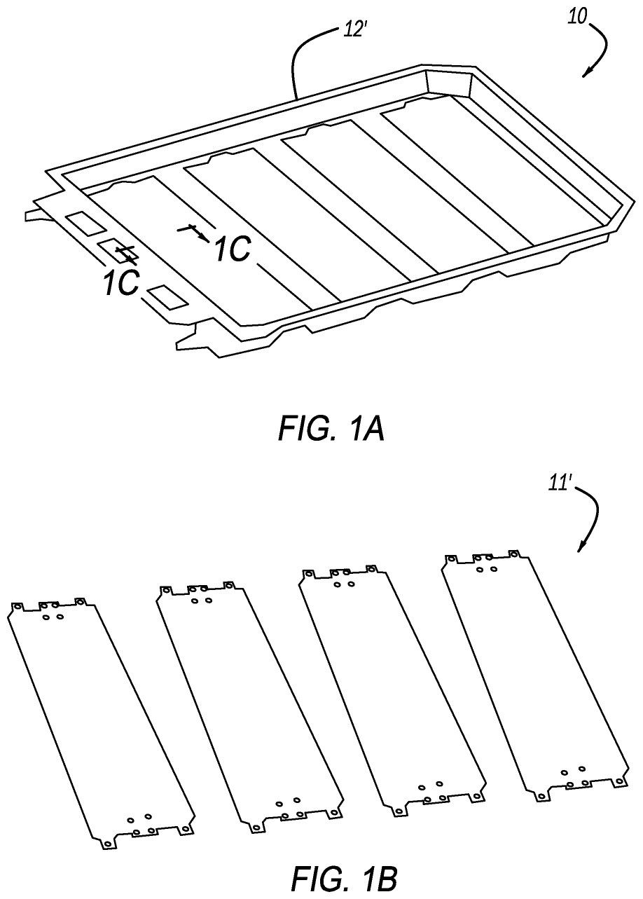

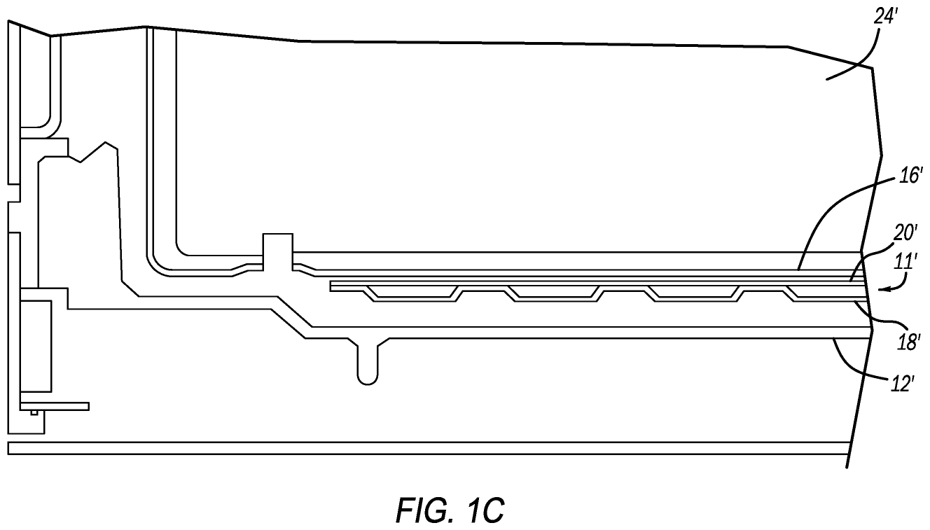

FIGS. 1A-1C illustrate a traditional system 10′ with a cooling plate assembly 11′ that includes a lower plate 18′ and a cover plate 20′, which are assembled together to define coolant channels 16′ therebetween. The external cooling plate assembly 11′ is arranged in the battery enclosure 12′ such that the cover plate 20′ is adjacent the battery modules or cells 24′. The present disclosure does not use such a separate assembly.

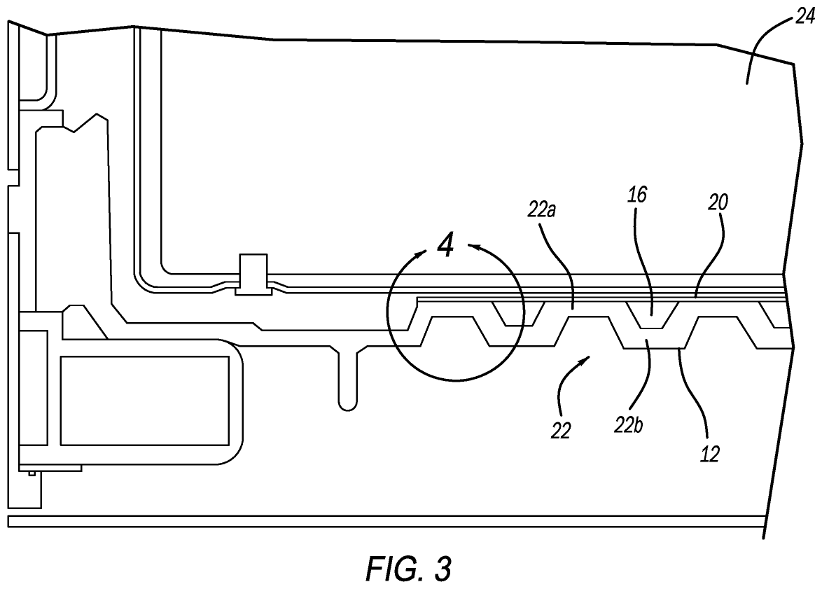

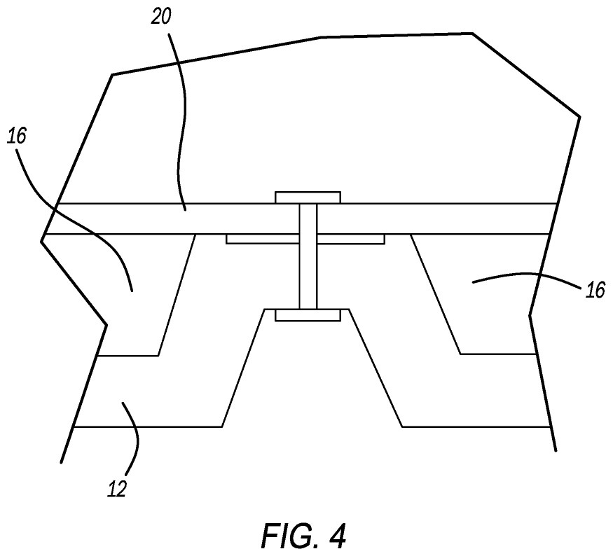

FIG. 2 illustrates an exploded view of one aspect of the present disclosure and illustrates system 10. The system 10 includes the battery enclosure 12, which includes a corrugated structure 22 formed in the bottom panel of the enclosure 12 that supports the battery cells 24. The corrugated structure 22 is arranged to define a serpentine path or channels along the enclosure 12, which extend laterally across the enclosure. The corrugated structure 22 has a wave-like structure with peaks 22a and valleys 22b, as shown in the cross-section of FIGS. 3 and 4. As shown in FIG. 2, there are four separate sections of channels, with the channels of each section extending up-and-down relative to the Figure. Each channel section includes an inlet and outlet for the coolant to be provided to, and retrieved from, the sections. Four plates 14 are shown separate from the enclosure 12 in this exploded view, with the plates 14 being laced upon the corrugations or peaks formed inside of the battery enclosure 12 to form and enclosure the channels.

In FIG. 2, plate 14 is a cover plate 20 that is attached to the tops of the peaks 22a of the corrugated structure 22. The peaks 22a may have a generally flat profile to mate with the generally flat cover plate 20. The cover plate 20 extends across the peaks 22a, or from peak to peak, thereby defining the coolant channels 16 between the cover plate 20 and the bottoms of the valleys 22b (and the sidewalls of the corrugated structure 22). The structure forming the peaks and valleys is the same structure/material as the bottom enclosure 12. Thus, the cover plate 20 is attached directly to the bottom panel of the battery enclosure 12. In this regard, the bottom enclosure 12 defines, in part, the coolant channel, with the plate, in this case cover plate 20 combining with the bottom enclosure 12 to define the coolant channel 16.

The cover plate 20 can mate with the bottom enclosure 12 via rivets, projection or draw-arc studs and nuts, or bolts and nuts. An adhesive may be applied between the cover plate 20 and the bottom enclosure 12. Of course, other attachment methods may be used.

FIG. 2 illustrates an aspect where the majority of the boundaries of the channel cross-section are formed by the battery enclosure 12 panel, due to the battery enclosure panel having the wavelike or corrugated structure 22. As described and shown later in this disclosure, the plate 14 that attaches to the battery enclosure may instead provide this structure, and combined with a flat bottom panel of the battery enclosure 12.

Various material combinations and mixing of materials may be used between the bottom enclosure 12 and the cover plate 12. In one aspect, the bottom enclosure 12 is plastic and the cover plate 20 is aluminum. In one aspect, the bottom enclosure 12 is fiber reinforced plastic and the cover plate 20 is aluminum.

Thus, the bottom enclosure 12 may be plastic or fiber reinforced plastic, and the cover plate 20 may be aluminum. Other material combinations may be used. However, as the cover plate 20 in the embodiment shown in FIG. 2 is the component that is adjacent the battery cell, this component is the one that is disposed between the coolant and the battery cell and the component that will transfer heat from the battery cell to the coolant in the channels. Accordingly, it is desirable that the component between the battery cell and the coolant, in this case the cover plate 20, have good heat transfer properties, and which is why aluminum is one preferred material. Similarly, the component not in direct contact with the battery cell can be plastic or fiber reinforced plastic.

The above-described system therefore integrates cooling into the structure of battery enclosure 12 itself, and eliminates the separate lower plates of traditional two-piece cooling plate assemblies. This approach provides the benefit of added value to the bottom enclosure manufacturer, part consolidation overall, mass and cost reduction, and capital and tooling savings.

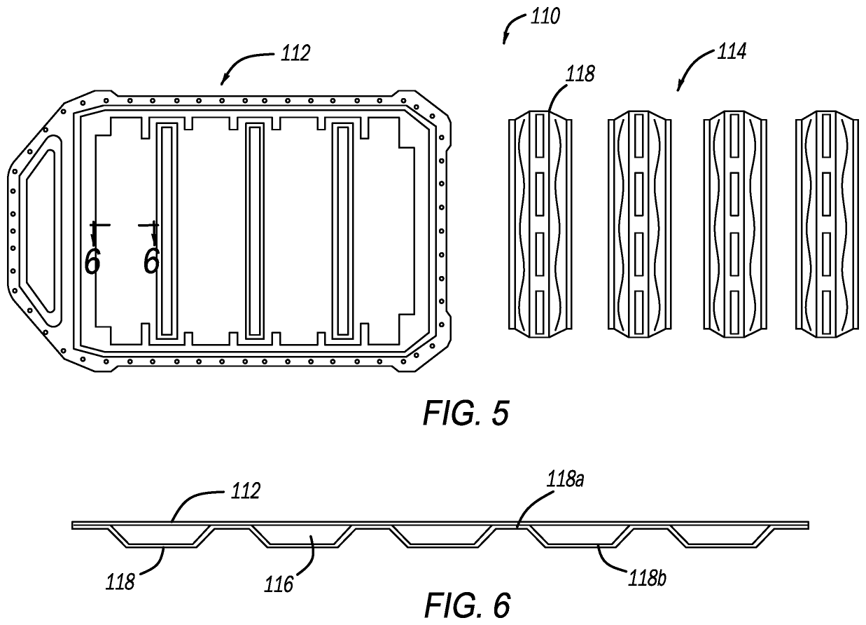

In another aspect, shown in FIGS. 5 and 6, a system 110 is shown having a battery enclosure 112 and plates 114 assembled thereto. In this aspect, plates 114 are in the form of lower plates 118. The system 110 differs from the system 10 in that the battery enclosure has the flat surface adjacent the battery cells, and the lower plates 118 have the corrugation and are mounted to the exterior of the battery enclosure. The lower plates 118 are corrugated, having peaks 118a and valleys 118b that define, in part, coolant channels 116 when then lower plate 118 is attached to the bottom of battery enclosure 112. In this aspect, the lower plate 118 is attached to the bottom surface of the battery enclosure 112. The battery enclosure 112, in this aspect, does not have the channels formed therein, but is instead generally flat. The generally flat battery enclosure 112 mates with the peaks 118a of the lower plate 118 to define the channels 116. Or, put another way, the peaks 118a of the lower plate 118 are attached to the flat bottom of the battery enclosure 112.

Thus, unlike cover plates 20 described above, which are generally flat and attached to the upper surface of the enclosure 12, the lower plates 118 have the wave-like structure and are attached to the lower flat surface of the enclosure 112. In both cases, the plate-structure attaches directly to the enclosure structure, with the battery enclosure 12, 112 combined with this additional structure 20, 118 to define the coolant channels therebetween. In both cases, a flat and thermally conductive surface is adjacent the battery cell held within the battery enclosure, with the difference being whether it is the plate 20 or the battery enclosure 112 that is this flat adjacent component.

The lower plates 118 may be attached to the bottom of the battery enclosure 112 via roll bonding, brazing, laser welding, adhesive and riveting/projection, draw-arc studs and nuts, or bolts and nuts. Other attachment mechanisms may also be used.

In one aspect, the battery enclosure 112 is aluminum, and the lower plates 118 are also aluminum. Thus, material that is adjacent the battery cells, in this case the bottom enclosure 112, is aluminum. In the system 110, the lower plates 118 have the wave-like structure and define the majority of the channel cross-section, and the enclosure 112 with the flat bottom panel does not.

It will be appreciated that other materials having good thermal conductivity may be used as the battery enclosure 112, which is the component adjacent the battery cells and which transfers heats to the coolant in the channels. In one aspect, the lower plates 118 may be plastic or fiber reinforced plastics or another material sufficient to convey coolant. The material of the lower plate 118 may be selected based on the material of the battery enclosure 112 and which mates well with such material such as via adhesive or welding. Thus, it may be desirable if the battery enclosure 112 is aluminum to use aluminum for the lower plates 118.

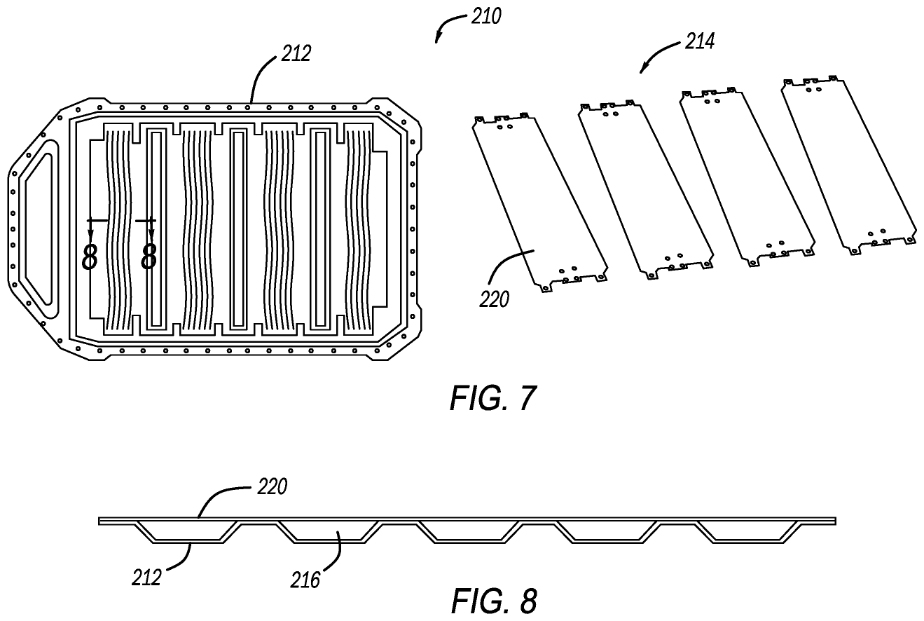

In another aspect, shown in FIGS. 7 and 8, system 210 is similar to system 10 and includes battery enclosure 212 and plates 214 attached thereto. In this aspect, plates 214 are in the form of flat cover plates 220. The enclosure 212 has the wave-like structure, and the flat cover plates 220 are attached to the peaks of such structure. The system 210 is therefore similar in structure and assembly stack-up as the system 10 described above, and further structural aspect will not be described in detail, as such aspects of system 10 also apply to system 210.

In one aspect, the enclosure 212 of system 210 may be a steel structure. The corrugated or wave-like shape formed in the enclosure 212 may be formed via stamping, machining, or the like. The cover plates 220 may be steel cover plates. The enclosure 212 and cover plates 220 may be joined via brazing, adhesive and riveting/projection, draw-arc studs and nuts, or bolts and nuts.

In the system 210, the enclosure 212 has the serpentine and wave-like or corrugated formations, and the cover plates 220 do not, similar to enclosure 12 and covers plates 20 described previously.

In this aspect, the cover plate 220 being steel provides for good heat transfer to the coolant flowing through the channels that are formed predominantly by the steel wave-like or corrugated form of the battery enclosure. The steel battery enclosure 212 may be less expensive than aluminum or fiber reinforced plastic enclosures, and may be easier to machine. The battery enclosure 212 and cover plate 220 combination provides similar advantages with regard to reduced components and the lack of a separate assembly to create cooling plate assemblies. The use of the steel cover plate 220 still provides good heat transfer into the coolant.

Similar to system 10, system 210 may use other materials sufficient to form the channels for battery enclosure 212 and to convey coolant, and the cover plate 220 may be another material having good heat transfer properties to transfer heat from the battery cells to the coolant flowing on the opposite side of the cover plate 220.

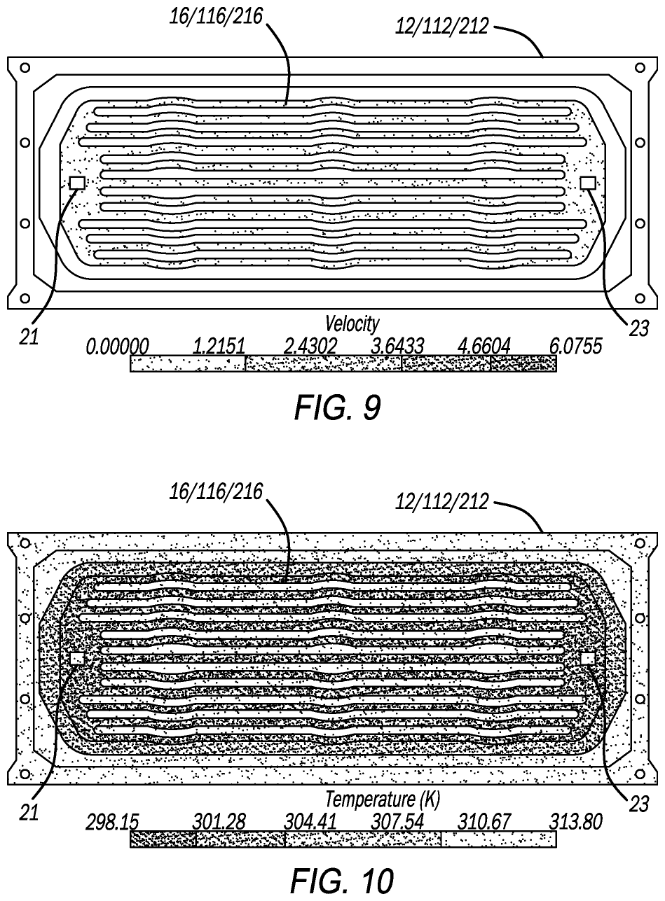

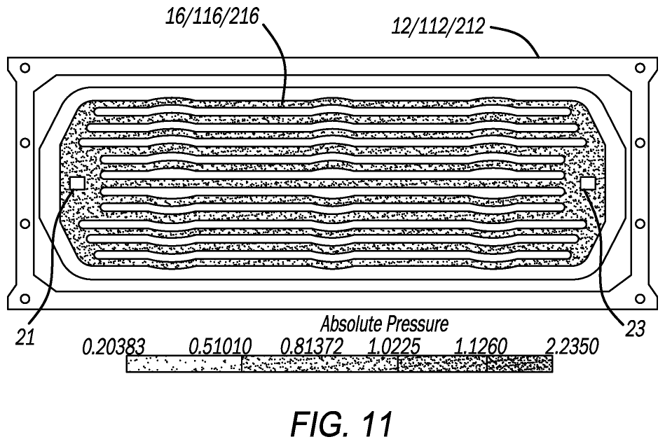

The above-described integrated cooling plates perform equal or better to the traditional external cooling plates. FIGS. 9-11 illustrates such performance with regard to flow velocity, pressure drop, and temperature. The path and pattern of the channels 16/116/216 for trays 12/112/212 are shown in FIGS. 9-11, with coolant being distributed between an inlet 21 and an outlet 23 of the flow path of the coolant. FIG. 9 illustrates the flow path from left to right between the inlet 21 and the outlet 23, and the flow velocity through this path meets or exceeds the flow velocity provided by traditional cooling plate assemblies. FIG. 10 illustrates how the temperature throughout the region covered by the channels 16/116/216 is lower than the areas outside of the channels 16/116/216 where coolant is not flowing. Adjacent the inlet 21 temperature is slightly lower as fresh coolant is introduced, and the coolant is heated as it flows through the channels and is exposed to the heat from the battery cells. FIG. 11 illustrates the pressure drop in the channels. Pressure is higher near the inlet 21 than the outlet 23.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

1. An integrated battery cooling system comprising:
a battery enclosure configured for housing one or more battery cells therein;
a plate attached to the battery enclosure;
a coolant path defined by the battery enclosure and the plate, wherein one of the battery enclosure and the plate has a wave-like structure that combines with the other of the battery enclosure and the plate to define the coolant path between the plate and the battery enclosure.

2. The system of claim 1, wherein the battery enclosure includes the wave-like structure and the plate is a planar cover plate attached to the top of the wave-like structure to form a plurality of channels and define the coolant path.

3. The system of claim 2, wherein the cover plate is aluminum.

4. The system of claim 3, wherein the battery enclosure is aluminum.

5. The system of claim 3, wherein the battery enclosure is plastic or fiber reinforced plastic.

6. The system of claim 2, wherein the cover plate is sandwiched between the battery enclosure and a battery cell.

7. The system of claim 2, wherein the cover plate is steel.

8. The system of claim 7, wherein the battery enclosure is steel.

9. The system of claim 1, wherein the plate is a single plate without enclosed channels and is directly attached to the battery enclosure to form channels for the coolant path by combining the plate with the battery enclosure.

10. The system of claim 1, wherein the plate is a lower plate and includes the wave-like structure, wherein the lower plate is attached to the bottom of the battery enclosure to define a plurality of channels and the coolant path.

11. An integrated battery cooling system comprising:
a battery enclosure configured for housing one or more battery cells therein;
a lower plate attached to the battery enclosure;
a coolant path defined by the battery enclosure and the lower plate, wherein the lower plate has a wave-like structure that combines with the battery enclosure to define the coolant path between the plate and the battery enclosure;
wherein the lower plate is attached to the bottom of the battery enclosure to define a plurality of channels and the coolant path; and
wherein the lower plate with the wave-like structure is attached to an exterior surface of a flat bottom of the battery enclosure.

12. The system of claim 11, wherein the battery enclosure is aluminum and the lower plate is aluminum.

13. The system of claim 11, wherein the lower plate is plastic or fiber reinforced plastic.

14. The system of claim 1, wherein the innermost of the battery enclosure or the plate is aluminum and is disposed adjacent the battery cells when the battery cells are placed within the battery enclosure.

15. A method of integrating a cooling channel with a battery enclosure, the method comprising the steps of:
providing a battery enclosure for housing one or more battery cells therein;
attaching a plate to the battery enclosure, and defining a coolant channel between the plate and the battery enclosure, wherein the coolant channel is configured to remove heat from the battery cells;
wherein one of the battery enclosure or the plate includes a wave-like structure, and attaching the plate to the battery enclosure defines the coolant channel within the wave-like structure.

16. The method of claim 15, wherein the battery enclosure includes the wave-like structure and the plate is a cover plate, wherein the method includes attaching the cover plate to the top of the wave-like-structure within the battery enclosure to define the coolant channels, such that the cover plate is disposed between the battery cells and the battery enclosure.

17. The method of claim 15, wherein the plate is a lower plate and includes the wave-like structure, and the method includes attaching the lower plate to an exterior surface of the bottom of the battery enclosure to define the coolant channels, such that the bottom of the battery enclosure is disposed between the battery cells and the lower plate.

18. The method of claim 15, wherein the plate is a single plate and does not define enclosed channels until being attached directly to the battery enclosure.

19. The method of claim 15, wherein one of the battery enclosure or the plate is adjacent the battery cell and defines a heat-transferring adjacent component.

20. The method of claim 19, wherein the heat-transferring adjacent component is steel or aluminum.
